(19) United States
(12) Patent Application Publication
(10) Pub. No.: US 2020/0285257 A1
(43) Pub. Date: Sep. 10, 2020

(54) CARTRIDGE FOR A MIXING VALVE

(71) Applicant: VERNET, DLLAINVILLE (FR)

(72) Inventors: Axel BELAIR, BRUYERES LE CHATEL (FR); Pierre-Olivier FASSOLETTE, CORBEIL ESSONNES (FR)

(21) Appl. No.: 16/648,894

(22) PCT Filed: Sep. 18, 2018
(86) PCT No.: PCT/EP2018/075190

§ 371 Date: Mar. 19, 2020

(30) Foreign Application Priority Data
Sep. 19, 2017 (FR) 1758673

(51) Int. Cl. G05D 23/13

(52) U.S. Cl. CPC G05D 23/1353

(57) ABSTRACT

A cartridge has a controller, which is movable between an initial position, an intermediate position and a terminal position, an adjuster, which includes a positioner actuated by the controller from a retracted position to an extended position when the controller is moved from the intermediate position to the terminal position, a shutter, which is movable to differentially modify the respective flow rate entering the cartridge, a thermo-actuator, which has a primary part fixedly attached to the shutter and a secondary part moving relative to the primary part as a function of an outlet temperature, and an over-travel spring, which is interposed between the positioner and the secondary part. The positioner is held in the retracted position, when the controller is moved from the initial position to the intermediate position.

### PRIORITY AND CROSS REFERENCE TO RELATED APPLICATIONS

This application is the U.S. National Phase Application under 35 U.S.C. § 371 of International Application No. PCT/EP2018/075190, filed Sep. 18, 2018, designating the U.S. and published in English as WO 2019/057706 A1 on Mar. 28, 2019, which claims the benefit of French Application No. FR 1758673, filed Sep. 19, 2017. Any and all applications for which a foreign or a domestic priority is claimed is/are identified in the Application Data Sheet filed herewith and is/are hereby incorporated by reference in their entireties under 37 C.F.R. § 1.57.

### FIELD

The invention relates to the field of taps, in particular for sanitary purposes.

### SUMMARY

The present invention relates to a cartridge for a mixing valve, a mixing valve comprising such a cartridge and a method of operating such a cartridge.

### BRIEF DESCRIPTION OF THE DRAWINGS

The invention and its advantages will be better understood in the light of the examples described below, given by way of nonlimiting example, with reference to the appended drawings, wherein:

FIG. 1 shows a perspective view of a cartridge according to the invention;

FIG. 2 shows a view from below of the cartridge of FIG. 1;

FIG. 3 shows a perspective view of a part of the cartridge of the preceding figures;

FIG. 4 shows a view from below of a part of the cartridge of the preceding figures;

FIGS. 5 to 10 show longitudinal sections of the cartridge of the preceding figures, according to the section line V-V of FIG. 4, showing the cartridge in several different operating configurations;

FIG. 11 shows a perspective view of a part of the cartridge of the preceding figures; and

FIGS. 12 and 13 show perspective views from two different angles, of a part of the cartridge of the preceding figures.

### DETAILED DESCRIPTION

In this field, a cartridge is a device that makes it possible, by actuating a controller, or several controllers, to regulate the flow rate of a flow of cold fluid and the flow rate of a flow of hot fluid, in particular flows of water, in order to mix these two flows and thus form an outgoing flow, whose temperature and flow rate are the result of this regulation. A cartridge is referred to as “single control cartridge” when a single controller, for example a single lever or a single button, is used to adjust both the flow rate and the temperature of the outgoing flow. A cartridge is referred to as “double control cartridge” when the operation of one controller changes the temperature, while the operation of another controller changes the flow rate. A cartridge is referred to as a “thermostatic cartridge” when it incorporates a thermo-actuator participating in this regulation of the flow rate and temperature.

FR 3 047 534 A1 discloses an example of a particular type of cartridge referred to as a “sequential thermostatic cartridge”, in which, apart from the above-mentioned thermostatic regulation, the controller follows an angular stroke, during which the controller first causes an increase in the flow rate of the outgoing flow at a constant temperature, and then an increase in the temperature of the outgoing flow at a constant flow rate.

In known manner for this type of sequential cartridge, the controller actuates a disc that is rotatable relative to a fixed disc, so as to face a system of channels formed by the two discs as a function of the angular position of the rotary disc. For this type of specific cartridge, it is necessary in practice for the rotary disc to effect a relatively large angular stroke with respect to the fixed disc, for example about 150°, to allow the successive functions of the sequential cartridge to be implemented: firstly, increasing the flow rate of the outgoing flow at constant temperature, then the gradual increase of the temperature without variation of the flow rate.

To ensure the thermostatic regulation, the cartridge also comprises a slide that is axially movable in translation between two stops corresponding to extreme positions of the slide, referred to as “full cold” and “full hot”, in order to inversely vary the flow rates of the flow of water having passed through the discs. The position of the rotary disc and the slide are mechanically linked via a coaxial screw-nut system and a thermostatic actuator, wherein an over-travel spring is axially interposed between them. Therefore, the position of this slide depends both on the expansion of the thermostatic element and the position of the rotary disc.

At the beginning of the angular stroke of the rotary disc, corresponding to the case where the two incoming flows are closed by the discs, the screw of the screw-nut system is in its lowest position along the axis. The screw-nut system transmits the rotation of the rotary disc to the screw, so that the screw translates axially to a high position reached at the end of angular stroke of the rotary disc, which corresponds to the case where the flow rate and the temperature of the outgoing flows are at a maximum. Insofar as, for this type of cartridge, the angular stroke is particularly important, it occurs that a first angular sector of the rotary disc includes the start of the stroke, wherein the position of the screw is so low that the slide is blocked at full cold. As a result, the over-travel spring interposed between the screw and the slide is compressed for this first angular sector. In particular, the over-travel spring is compressed very significantly at the start of the stroke, which corresponds to the case where the incoming flow is closed: this closure configuration is the one most used during the life of the cartridge. Because of this excessive and prolonged compression, the over-travel spring may lose its stiffness, or be damaged, so that it no longer provides its over-travel function. When the spring deteriorates, it is possible that the slide may no longer reach the full cold position, which may be detrimental not only for the regulation of the temperature of the outgoing flow, but also in terms of safety of the user in the event of the slide closing badly, or no longer closing the passage of hot water.

The invention aims to remedy the drawbacks of the prior art by proposing a new cartridge reliably guaranteeing the state of the over-travel spring over time.

The invention relates to a cartridge for a mixing valve, wherein the cartridge comprises: two inlets of incoming flows of liquid; a chamber, designed to form an outgoing flow by mixing the incoming flows; a controller, which is movable relative to the chamber between an initial position and a terminal position, passing through an intermediate position between the initial position and the terminal position; an adjuster, which comprises: a positioner, which is movable relative to the chamber upon being actuated by the controller so as to be displaced relative to the chamber from a retracted position to an extended position when the controller is moved from the intermediate position to the terminal position; a shutter, which is movable with respect to the chamber for differentially modifying the respective flow rate of the incoming flows; a thermo-actuator, which comprises a primary part fixedly attached to the shutter and a secondary part moving relative to the primary part as a function of an outlet temperature of the outgoing flow; and an over-travel spring, which is interposed between the positioner and the secondary part of the thermo-actuator. According to the invention, the positioner is held in the retracted position, when the controller is moved from the initial position to the intermediate position.

Thanks to the invention, the positioner is only moved for a continuous range of the stroke of the controller, namely the intermediate position and the terminal position. Over this range of the stroke of the controller, thermostatic regulation of the flow rate of the incoming flows is carried out at least as well as in the prior art, since the position of the positioner varies according to the position of the controller, so that the position of the positioner depends on both the thermo-actuator and the controller. For another continuous range of the stroke of the controller, namely between the initial position and the intermediate position, the positioner is maintained in the same position, which avoids unnecessary stressing of the over-travel spring and so ensure its good condition in a sustainable way.

Advantageous and optional features of the invention to be considered in any technically feasible combination are defined in the following:
the cartridge defines a fixed main axis with respect to the chamber; the controller is pivotally movable about the main axis from the initial position to the terminal position relative to the chamber; the positioner is movable in translation parallel to the main axis from the retracted position to the extended position relative to the chamber; and the adjuster comprises a mechanical connection through which the controller actuates the positioner, wherein the mechanical connection comprises: at least one radial tooth which protrudes radially with respect to the main axis from a first member among the controller and the positioner; at least one meshing path of the radial tooth which is recessed in a second member of the controller and the positioner.
each meshing path comprises: a helical thread, which is coaxial with the main axis, so that when the controller is moved from the intermediate position to the terminal position, the positioner is moved relative to the chamber from the retracted position to the extended position by the meshing of the radial tooth with the helical thread; and a radial notch, beginning at the end of the helical thread and extending in a plane orthogonal to the main axis, so that when the controller is moved from the initial position to the intermediate position, the positioner is held in the retracted position by the axial capture of the radial tooth in the radial notch.
the shutter is movable relative to the chamber, between: a safety position in which the shutter closes the first incoming flow and allows the second incoming flow; and an opposite position in which the shutter closes the second incoming flow and allows the first incoming flow.
the secondary part of the thermo-actuator is movable, relative to the positioner between a normal stroke position and an over-travel position; and the over-travel spring exerts a return force on the secondary part that tends to return the secondary part to the normal stroke position when the secondary part is brought into the over-travel position.
the secondary part of the thermo-actuator moves with respect to the primary part, from at least one retracted position to at least one extended position as a function of the outlet temperature; and the controller passes through a non-forcing position when moved between the initial position and the terminal position, so that: when the controller is between the initial position and the non-forcing position, the secondary part of the thermo-actuator is held in the over-travel position against the return force of the over-travel spring, while the shutter is held in the safety position, regardless of the secondary part being in the retracted position or in the extended position, and when the controller is between the non-forcing position and the terminal position, the secondary part of the thermo-actuator is in the normal stroke position at least when the secondary part is in the retracted position.
the controller passes through a single-opening position, when it is moved between the initial position and the intermediate position, and by a double-opening position, when it is moved between the intermediate position and the terminal position; and the cartridge further comprises a regulator that is designed to differentially vary the respective flow rate of the incoming flows as a function of the position of the controller, so that when the controller is between the initial position and the single-opening position the two incoming flows are closed by the regulator; when it is between the single-opening position and the double-opening position, one of the incoming flows is closed by the regulator and the other incoming flow is allowed by the regulator; and when it is between the double-opening position and the terminal position, the two incoming flows are allowed by the regulator.
the adjuster further comprises a return spring which is interposed between: on the one hand, the shutter or the primary part, and, on the other hand, the chamber.

The invention also relates to a mixing valve comprising a cartridge according to the above.

The invention also relates to a method of operating a cartridge according to the above, wherein: when the controller is moved from the initial position to the intermediate position, the positioner is held in the retracted position; and when the controller is positioned between the intermediate position and the terminal position, the positioner is moved from the retracted position to an extended position.

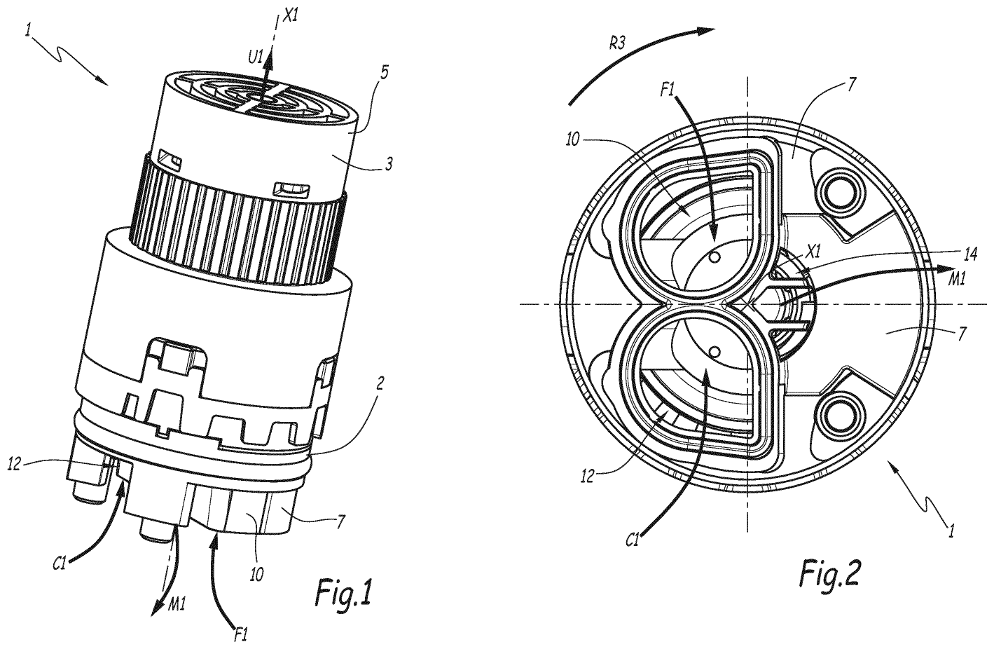

FIG. 1 shows a complete cartridge 1 that is intended to be integrated within a mixing valve for sanitary use (not shown). In the case of the example, the cartridge 1 is a sequential thermostatic cartridge. However, one could provide a cartridge 1 according to the invention, operating otherwise than sequential.

As may be seen in FIG. 1, the cartridge 1 comprises a housing 2 having a generally cylindrical shape with a circular base and geometrically defining a main axis X1. The housing 2 is intended to be fixed relative to the valve housing in which the cartridge 1 is integrated.

Unless otherwise stated, expressions such as “radial”, “axial” and “coaxial” refer to this axis X1. In addition, a main direction U1 is defined by the axis X1. Unless otherwise stated, expressions such as “upper”, “high” and “above” refer to the U1 direction, while expressions such as “lower”, “low” and “below” refer to a direction that is the reverse of the U1 direction.

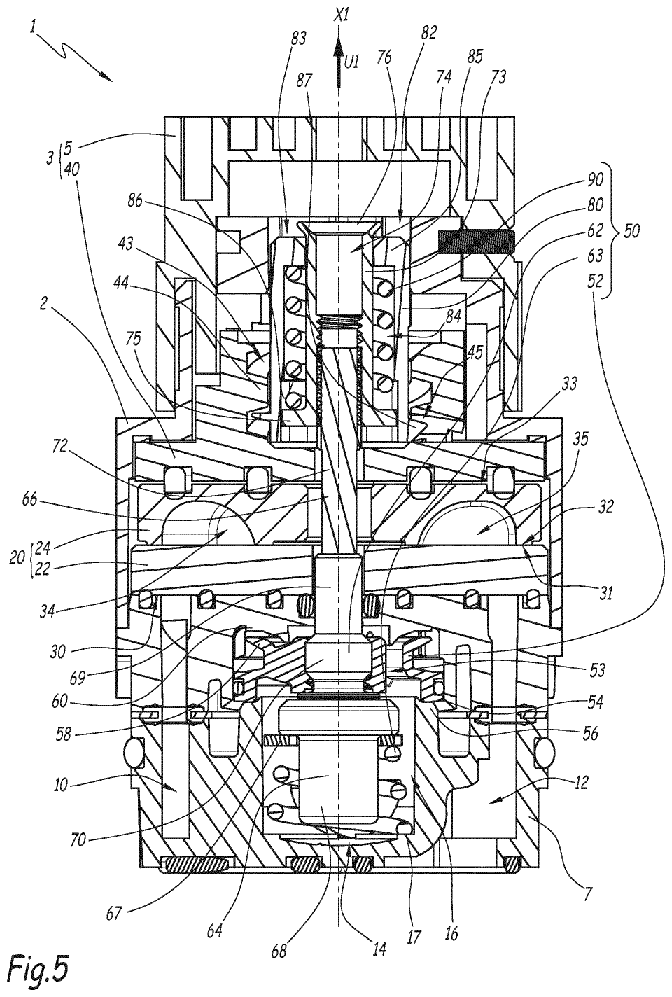

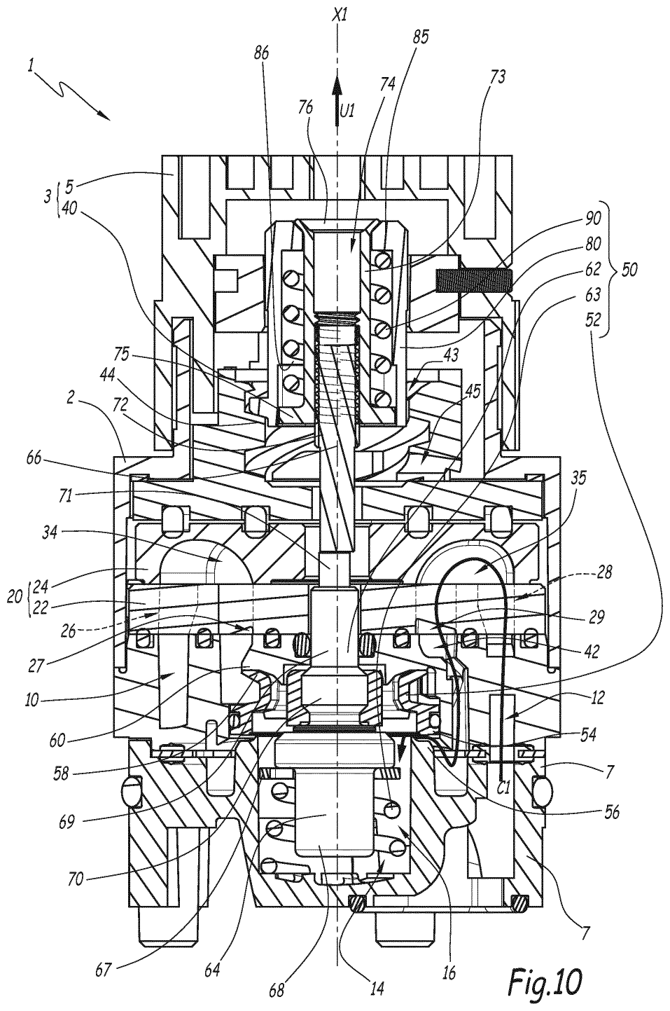

The cartridge 1 comprises a controller 3, i.e. a control member. In the present example, the controller 3 is an assembly of several parts fixed relative to each other and which may be pivoted about the axis X1 relative to the housing 2. The pivoting is effected from an initial position, shown in FIG. 5 to a terminal position shown in FIG. 10. Preferably, it is the only degree of freedom of the controller 3.

Alternatively, the controller 3 may be in the form of a single integral part.

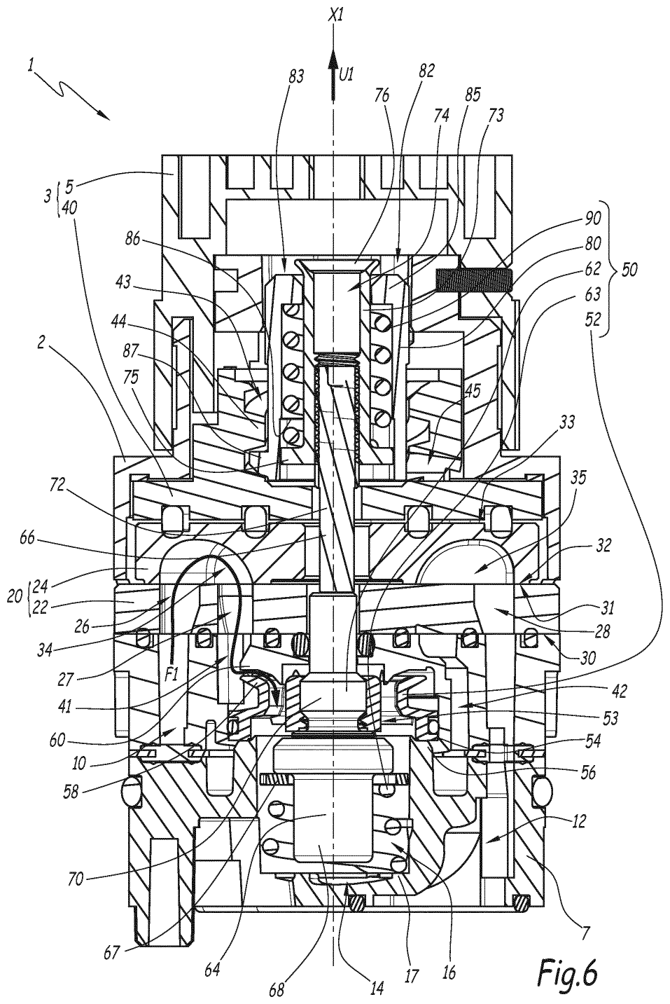

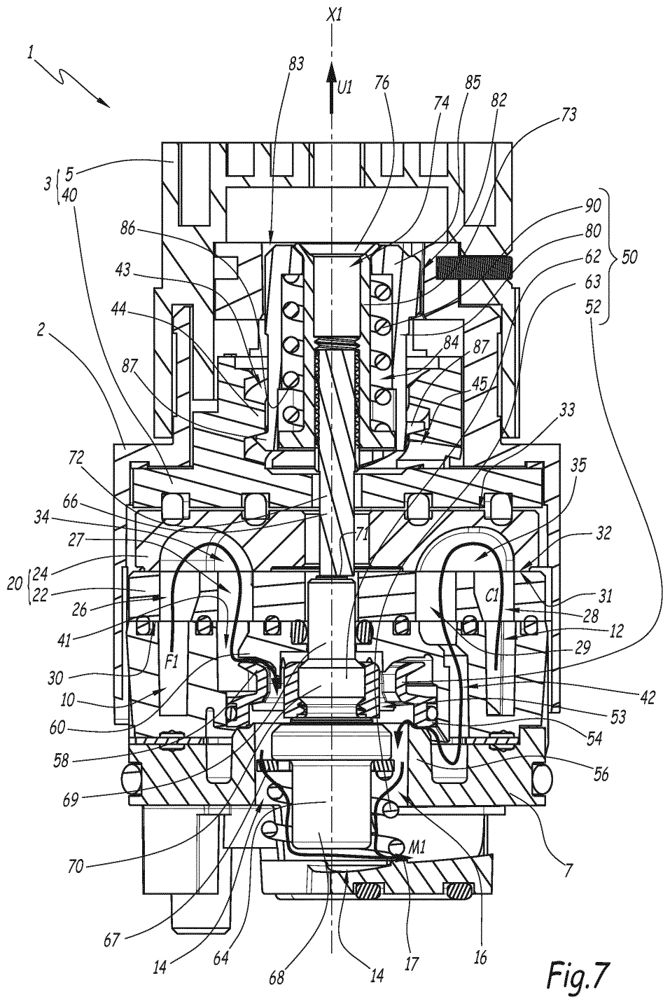

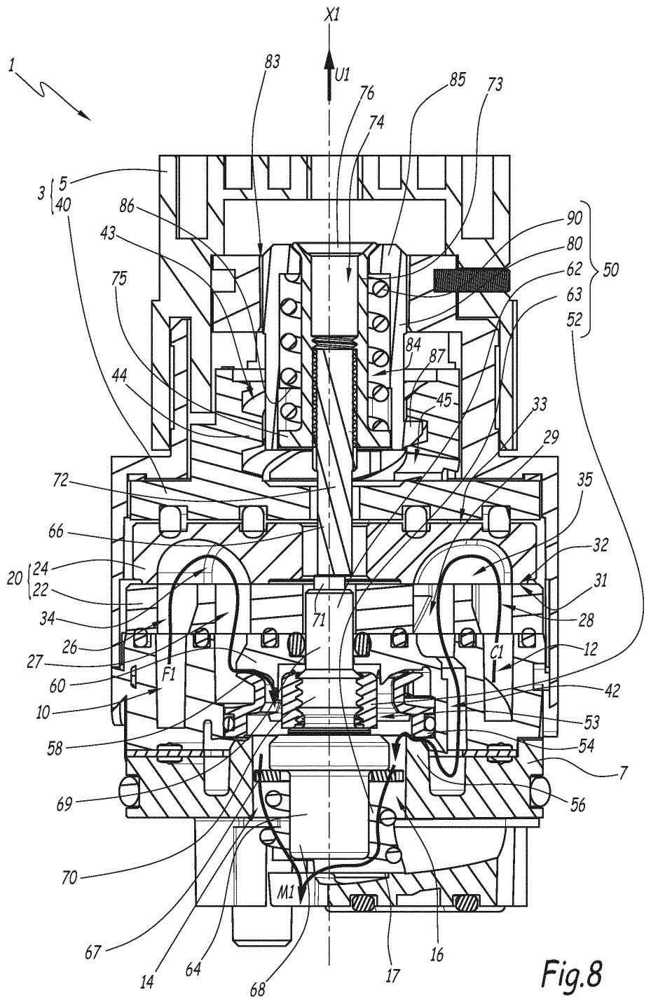

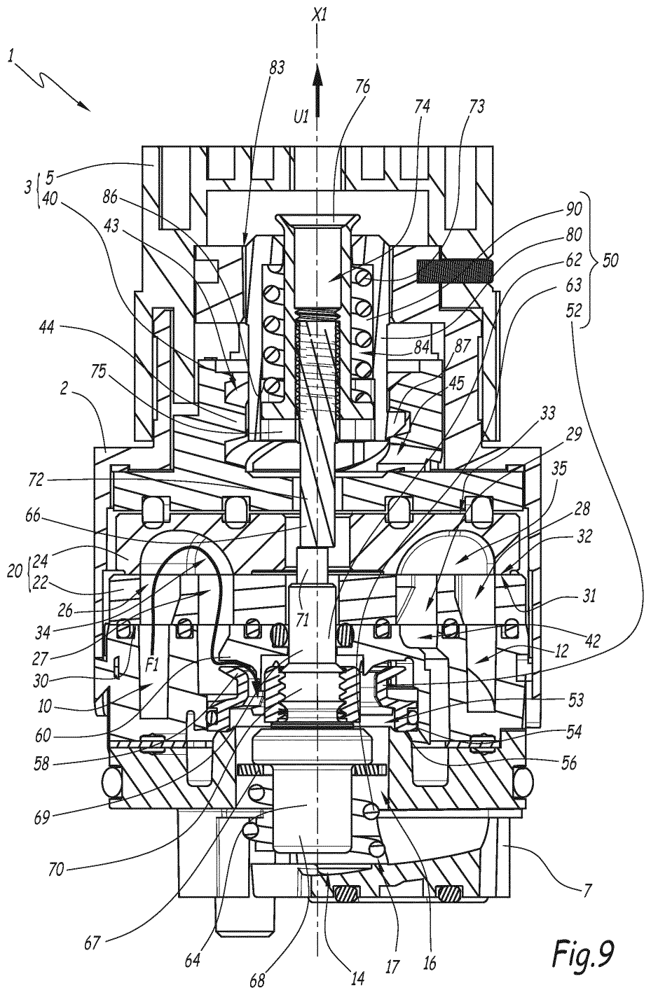

In addition, the cartridge 1 and its controller 3 are represented in the following configurations:
in FIG. 6, the controller 3 is positioned at 35° (degrees) with respect to the initial position;
in FIG. 7, the controller 3 is positioned at 70° with respect to the initial position;
in FIGS. 8 and 9, the controller 3 is positioned at 97° with respect to the initial position;
in FIG. 10, the controller 3 is positioned at 145° with respect to the initial position.

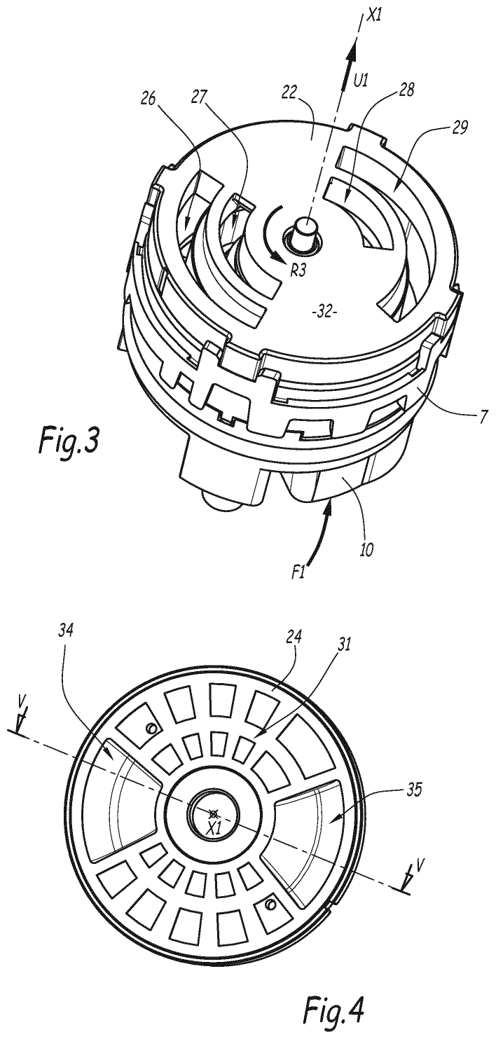

Unless otherwise stated, all angular degree values mentioned in this document are understood to be in rotation of the controller 3 about the axis X1 relative to the housing 2, and in the same direction of rotation as represented by the rotation arrow R3 visible in FIGS. 2 and 3.

As may be seen in particular in FIG. 1, the controller 3 comprises, in particular, a ring 5 which axially covers the top of the housing 2. The ring 5 is designed to be coupled to a valve control lever, preferably in a fixed manner, if not via a transmission mechanism, wherein a user of the tap may operate the controller 3 via the control lever and thus control the cartridge 1 and the tap.

At a lower end of the housing 2 located axially at the bottom of the cartridge 1, the cartridge 1 comprises a cold water inlet port 10, a hot water inlet port 12 and an outlet port 14 for outgoing water. In other words, the housing 2 comprises a base 7 forming a lower axial end part of the housing 2, wherein the orifices 10, 12 and 14 open from this base 7. These orifices 10, 12 and 14 open axially from the bottom end of the cartridge 1 as shown in FIG. 2. Typically, the flows of cold water and hot water are supplied to the base of the valve housing in order to enter into the housing 2. These flows of cold water and hot water are respectively represented by the arrows F1 and C1. The outgoing water is emitted outwards from inside the housing 2 to form an outgoing flow, represented by the arrow M1. The flow M1 is intended to be emitted via a spout. Specifically, when the cartridge 1 is integrated in the valve, the orifices 10 and 12 are in fluid connection with the cold water and hot tap water pipes, while the orifice 14 is in fluid connection with the spout of the tap.

More generally, the cartridge 1 comprises two inlets for the incoming flows of liquid F1 and C1, which enter the cartridge 1 from the outside of this cartridge 1. The cartridge 1 also comprises an outlet for an outgoing flow M1 of liquid, which exits outside the cartridge 1 from the inside of this cartridge 1. The liquids of the two incoming flows F1 and C1 are preferably provided at a temperature that is different by at least ten degrees, i.e. that of the cold temperature and hot temperature.

Alternatively, it may be provided that the liquid concerned is not water.

As illustrated in FIGS. 5 to 10, the outgoing flow M1 is obtained by mixing flows F1 and C1 with each other, wherein this mixture constitutes the outgoing flow M1. Mixing is performed within the cartridge 1, more specifically in a chamber 16 formed in the housing 2 that is in fluid connection with the orifice 14. The chamber 16 is fixed with respect to the housing 2 and the main axis X1. The incoming flows F1 and C1 come into contact with each other in the chamber 16 in order to be mixed, i.e. mixed with each other, to then form the flow M1. In normal operation, the flow rate of the flow M1 is equal to the sum of the flow rates of the flows F1 and C1, whereas the temperature of the flow M1 is a function of the flow rates and the respective temperatures of the flows F1 and C1. In the present example, the chamber 16 is provided at the height of the base 7, near the lower end of the cartridge 1, wherein the orifice 14 is formed at the bottom of the chamber 16. The chamber 16 is preferably crossed by the axis X1.

The cartridge 1 of the present example comprises and encloses a plurality of means for modifying and adjusting the respective flow rate F1 and C1 admitted into the cartridge in order to allow the regulation of the flow rate and temperature of the flow M1.

The cartridge 1 comprises a regulator 20, which is designed to modify or differentially adjust the respective flow rate of the flows F1 and C1 as a function of the position of the controller 3. In other words, the regulator 20 is able to variably limit, the flow rate of the flow F1 and to variably limit, differently, the flow C1, according to the orientation of the controller 3 imparted by the user. Since the incoming flows F1 and C1 are each supplied at a certain pressure, the regulator 20 is able to limit the establishment of flow rates for each of the incoming flows F1 and C1, between:
a null flow rate value, for which concerned the flow does not flow, as a result of closing, and
a maximum flow rate value, for which the flow rate of the concerned flow is allowed to be set at a maximum value upon opening.

Preferably, the regulation of the flow rates by the regulator 20 is determined solely by the position of the controller 3; it is not dependent on any other element of the cartridge 1. In particular, the thermo-actuator 62 of the cartridge 1, defined below, does not actuate the regulator 20.

Any type of regulator performing these functions may be provided for the cartridge 1. In the present example, as shown in FIGS. 5 to 10, there is a disc regulator 20 contained in the housing 2. The regulator 20 comprises an upper rotary disc 24, shown only in FIG. 4, and a fixed lower disc 22, shown bare in FIG. 3. In FIG. 3, only the lower part of the cartridge is shown, including the base 7. The discs 22 and 24 are coaxial with the axis X1 and are applied to each other in a sealed manner. For this, the discs 22 and 24 are preferably made of ceramic.

The disc 22 is fixed to the base 7 and is thus fixed relative to the chamber 16. The disc 22 is axially traversed by four openings or channels 26, 27, 28 and 29, which are each in the shape of an arc of a circle that is concentric with respect to the axis X1. The pair of channels 26 and 27 are arranged diametrically opposite, and approximately symmetrical to the pair of channels 28 and 29 with respect to the axis X1. The channels 26 and 27 extend in the same angular sector of the disc 22, wherein the channel 26 is external while the channel 27 is internal. The channels 28 and 29 extend in the same angular sector of the disc 22, wherein the channel 28 is external while the channel 28 is internal. As may be seen in FIGS. 6 to 9, the orifices 10 and 12 are respectively in fluid connection to the channels 26 and 28, via a lower axial face 30 of the disc 22.

The disc 24 is linked, even fixedly linked, in rotation about the axis X1, to a nut 40 of the controller 3, via an upper axial face 33 of the disc 24. The nut 40 that is enclosed in the housing 2 above the discs 22 and 24, is itself linked, even fixedly linked, in rotation about the axis X1, to the ring 5, wherein the ring 5 extends above the nut 40. The disc 24 and the nut 40 have a degree of freedom, and preferably a single degree of freedom for rotation about the axis X1, with respect to the chamber 16. The action of the user on the controller 3 directly rotates the disc 24 relative to the chamber 16. It should be noted that the sectional plane of FIGS. 5 to 10 is fixed relative to the disc 24 and relative to the controller 3. Whatever the orientation of the disc 24, a lower axial face 31 of the disc 24 flatly abuts the upper axial face 32 of the disc 22, wherein this contact is sealed against the liquid flowing in the cartridge 1. The disc 24 comprises two pockets 34 and 35, opening at its lower axial face 31. The pockets 34 and 35 are blind. The pockets 34 and 35 are arranged diametrically opposite to the axis X1. Each pocket 34 and 35 extends over a smaller angular sector than all or part of the channels 26, 27, 28 and 29. The pockets 34 and 35 are respectively associated with a pair of channels 26, 27 and 28, 29. Each pocket 34 and 35 extends radially so as to be able to open in both channels of the pair of channels associated therewith as a function of the position of the disc 22. For example, in the configuration of FIG. 6, the pocket 34 opens on the channels 26 and 27 in order to be in fluid communication, while the pocket 35 opens on the channels 28 and 29 in order to be in fluid communication. When the channels 26 and 27 are thus in fluid communication, the regulator 20 does not oppose the establishment of a flow rate for the flow F1, i.e. the flow F1 is allowed. When the channels 28 and 29 are thus in fluid communication, the regulator 20 does not oppose the establishment of a flow rate for the flow C1, i.e. the flow C1 is allowed. For certain orientations of the disc 24, as shown for example in FIG. 5, the fluid communication between the channels 26 and 27 is closed by the disc 22, wherein the pocket 35 opens on a part of the face 32 where at least one of the channels 26 and 27 does not open. Then, the flow rate F1 is null. Similarly, for some orientations of the disc 24, as for example in FIGS. 5 and 6, the fluid communication between the channels 28 and 29 is closed by the disc 24, wherein the pocket 35 opens on a part of the face 32 where at least one of the channels 28 and 29 does not open. Then, the flow rate of the flow C1 is null.

Whether related to a disc or another mode of operation, it is preferred that the regulator 20 is configured for sequential operation. In the illustrated example of a sequential disc regulator, it is the distribution of the channels and pockets within the discs 22 and 24 that makes it possible to effect such an operation. To ensure such a sequential operation, it is advantageously provided that the controller 3 performs a stroke greater than 100°, or even greater than 130°. In the example shown, the controller 3 effects a 145° stroke from the initial position to the terminal position. When moved, i.e. rotated, from the initial position to the terminal position in the direction R3, the controller 3 passes through a single-opening position and a double-opening position. In this case, when the controller 3:
is between the initial position and the single-opening position, the flows F1 and C1 are closed by the regulator 20, i.e. they have a null flow rate, which leads to a null flow rate for the outgoing flow M1, as it is the case in FIG. 5;
is between the single-opening position and the double-opening position, the flow C1 is closed and the flow F1 is allowed by the regulator 20, as it is the case in FIG. 6, so that, subject to the action of the adjuster 50 described below, the outgoing flow M1 is exclusively constituted by the flow F1 due to the absence of C1 flow in the mixture; and
is between the double-opening position and the terminal position, the flows F1 and C1 are allowed by the regulator 20, as it is the case in FIGS. 7 to 10, so that, subject to the action of the adjuster 50 described below, the outgoing flow M1 is a mixture of the flows F1 and C1.

In FIG. 6, it may be seen that the channel 28 is not closed by the disc 24, while the channel 29 is closed, so that the flow C1 has a null flow rate.

In FIG. 10, it may be seen that the channels 26, 27, 28, 29, shown in dashed lines because they are outside the cutting plane, are not blocked by the disc 24. In FIG. 10, the regulator 20 does not oppose to the establishment of a flow rate for the flows F1 and C1. Nevertheless, the opening of the channels 26 and 27 is smaller than that of the channels 28 and 29, so that the regulator 20 allows the establishment of a high flow rate for the flow C1 and a lower flow rate for the flow F1. As explained below in the case of FIG. 10, the adjuster 50 opposes to the establishment of the flow F1, so that the flow F1 has null flow rate even if it is allowed by the regulator 20.

The single-opening position is, for example, reached at a position of the controller 3 between 0° and 35° relative to the initial position, for example about 10°, or in the same proportions of the total stroke of the controller 3. The double-opening position is, for example, reached between 35° and 70°, for example between 55° and 70°, or in the same proportions of the total stroke.

The regulator 20 comprises two separate outlets, respectively for the flows F1 and C1, the flow rate of which has been adjusted by the regulator 20. These separate outlets are internal to the cartridge 1 and formed in the example shown by the channels 27 and 28 of the fixed disc 22. The channels 27 and 28, or more generally the two outlets, are respectively in fluid connection with intermediate ducts 41 and 42 formed in the base 7. In the present example, the ducts 41 and 42 are respectively in fluid connection with the channels 27 and 28 at the lower axial face 30 of the fixed disc 22 and extend below the regulator 20 in the vicinity of the chamber 16.

The ducts 41 and 42 are respectively in fluid connection to the chamber 16, so that the flows F1 and C1 mix only when they reach the chamber 16 and form the flow M1, as shown in FIG. 8.

The cartridge 1 also comprises a flow rate adjuster 50 for the flows F1 and C1, said adjuster 50 constituting a second means for modifying and adjusting the respective flow rate of the flows F1 and C1 admitted into the cartridge 1. The adjuster 50 is designed to act on the respective flow rate of the flows F1 and C1 as a function of both the position of the controller 3 and the value of the outlet temperature of the outgoing flow M1. More generally, the adjuster 50 provides a thermostatic regulation of the outlet temperature of the flow M1.

The adjuster 50 comprises a shutter or slide 52, which is housed in the upper part of the chamber 16, i.e. opposite the orifice 14. The shutter 52 is movable in translation parallel to the axis X1 relative to the chamber 16. This is advantageously its only degree of freedom, even if the shutter 52 may be free to rotate about the axis X1. The shutter 52 is movable along the axis X1 between:
a low position, called a “safety” or “full cold” position, in which the shutter 52 closes off the entering flow C1 while allowing the flow F1 as shown in FIGS. 5, 6 and 9, by placing a lower collar 54 of the shutter 52 in abutment against a lower seat 56 provided within the chamber 16, for example at the place where the intermediate duct 42 opens into the chamber 16; and
a high position, called the “opposite” or “full hot” position, in which the shutter 52 closes off the incoming flow F1 while allowing the incoming flow C1 as shown in FIG. 10, by placing an upper collar 58 of the shutter 52 in abutment against an upper seat 60 provided within the chamber 16, for example at the place where the intermediate duct 41 opens into the chamber 16.

The shutter 52 thus moves between the two seats 56 and 60. The closing contact between each of the necks 54 and 58 and their seat 56 and 60 respectively, is advantageously of circular shape and coaxial with the axis X1.

As shown in FIGS. 7 and 8, the shutter 52 is capable of adopting intermediate positions between the safety position and the opposite position, according to which the flows F1 and C1 are allowed to flow in complementary proportions. In other words, the shutter 52 inversely limits the flows F1 and C1, in other words, limits in an antagonist manner. When the shutter 52 is halfway between the safety and opposite positions, the flows F1 and C1 are equitably limited by the shutter 52. When the flow F1 is allowed by the shutter 52, said flow F1 passes through the shutter 52 from top to bottom via a through-orifice 53 provided through the shutter 52, as shown for example in FIG. 8. The mixture between the flows F1 and C1 is effected in the vicinity of the shutter 52 and below it. For example, the mixture is approximately at the height of the seat 56.

The adjuster 50 comprises a thermo-actuator 62, or thermostatic actuator, which comprises a primary part 64 fixedly attached to the shutter 52, and a secondary part 66 moving relative to the primary part as a function of the outlet temperature of the flow M1. For this, the thermo-actuator 62 is at least partially arranged in the chamber 16. The secondary part 66 moves, relative to the primary part 64, from one or more retracted positions that are visible, for example, in FIGS. 5 and 6, up to one or more protruding positions that are visible, for example, in FIGS. 7 to 10, as a function of the outlet temperature of the flow M1. The retracted position corresponds to a state of the thermo-actuator 62 in which its length, measured axially, is at its lowest. In the protruding position, the thermo-actuator 62 has a longer axial length. The retracted position is preferably obtained at lower temperatures, for example below about 25° C., while the protruding position is preferably obtained at higher temperatures, for example above about 25° C.

The thermo-actuator 62 itself is movable at least in translation, as a whole, with respect to the chamber 16, insofar as the primary part is fixedly attached, or is at least linked in translation along the axis X1, with the shutter 52. Preferably, the secondary part 66 of the thermo-actuator 62 moves in translation parallel to the axis X1 with respect to the primary part 64, which constitutes its only degree of freedom, except, optionally, for free rotation about the axis X1. In the present example, the parts 64 and 66 of the thermo-actuator 62 are geometrically coaxial, or almost coaxial, with the axis X1. Preferably, the primary part 64 is located below the secondary part 66.

In the illustrated example, the thermo-actuator 62 comprises a thermostatic element containing a heat-expandable material not visible in the figures, such as a wax. Alternatively, for example, a thermo-actuator comprising or consisting of a shape-memory alloy could be provided.

In the illustrated example, the primary part 64 belongs to the thermostatic element and comprises, as shown in FIGS. 5 to 10:
at a lower end, a cup 68, which encloses the heat-expandable material and extends in the chamber 16 into the passage of the flow M1, between the shutter 52 and the orifice 14;
at an upper end, a guide 69, which guides the translation of the primary part 64;
at an intermediate part, a fastener 70 for fixing the shutter 52, for example by screwing, so that the shutter 52 surrounds the primary part 64.

The adjuster 50 further comprises a return spring 63, which is axially interposed between, on the one hand, the shutter 52 or the primary part 64, and on the other hand, the chamber 16 or any other fixed element relative to the housing 2. More specifically, the spring 63 exerts, through elasticity, a return force that tends to return and/or maintain the shutter 52 in the opposite position. In the present example, the spring 63 is in the form of a compression spring that is, for example helical coaxial with the axis X1. In the present example, the spring 63 extends around and along the cup 68. Preferably, the spring 63 is interposed between:
an axial surface facing downwards, preferably formed by a neck or caliper 67 carried by the cup 68, or more generally by the primary part 64, or otherwise formed on the shutter 52;
an axial surface facing upwards, advantageously formed by an internal radial collar 17 or any equivalent means of the chamber 16, at the bottom of the chamber 16, in particular in the vicinity of the orifice 14.

In the illustrated example, the secondary part 66 comprises:
a piston 71 that is visible in FIGS. 7 to 10, and that is carried and guided in translation by the guide 69 and moved by the heat-expansion material, wherein the piston 71 belongs to the thermostatic element;
an extension rod 72, whose lower end bears axially against the piston, wherein the rod 72 passes through the discs 22, 24 and the nut 40,
a limiter 73, which is axially screwed to the upper end of the rod 72, with a relatively fine pitch, so that the axial position of the limiter 73 on the rod 72 may be adjusted by screwing with a certain precision, which makes it possible to calibrate the thermostatic regulation of the outgoing flow M1 provided by the adjuster 50.

In the case of the example, the retracted positions of the thermo-actuator 62 correspond to the cases where the piston 71 is axially completely embedded or retracted in the guide 69, or more generally in the primary part 64. The protruding positions correspond to the cases where the piston 71 protrudes axially from the guide 69.

In the example shown, the limiter 73 has an axially-tubular shape, so as to provide an axial through-duct 74. Preferably, the limiter 73 is coaxial with the axis X1. At the bottom of this duct 74 is an internal screw thread, which is screwed onto an external screw thread provided at the upper end of the rod 72. The duct 74 further allows screwing, since allowing the passage of a tool through the limiter 73 until it reaches the upper end of the rod 72, where an indentation is advantageously provided for the tool. Alternatively, the secondary part 66 comprises a means for adjusting the axial position of the limiter 73 that is different from the screwing system described above, or is devoid of such means for adjusting the axial position. Alternatively, at least two parts among the piston 71, the extension rod 72 and the limiter 73 are in the form of a single part.

The adjuster 50 comprises a positioner 80, shown alone in FIGS. 12 and 13, which is movable relative to the chamber 16 by being actuated by the controller 3. The positioner 80 is provided inside the housing 2, in particular in the vicinity of the upper end of this housing 2, in an axial chamber 83 of the housing, opposite the chamber 16 and opening upwards under the ring 5. In the case of this example, the positioner 80 is movable in translation relative to the chamber 16 and parallel to the axis X1, from a retracted position, i.e. a low position visible in FIGS. 5 and 6, to the extended position, i.e. a high position visible in FIG. 10. The positioner 80 advantageously comprises an anti-rotation tooth 81 that is, for example radial and external, or any other anti-rotation means, for it to be fixed in rotation around the axis X1 relative to the chamber 16, while being movable in translation parallel to the axis X1. In the present example, the tooth 81 is positioned towards the top of the positioner 80. As may be seen in FIG. 7, the tooth 81 of the present example is guided by an axial groove 82 formed in the upper part of the housing 2 and parallel to the axis X1, in particular in the chamber 83.

The positioner 80 is of axially-tubular shape, having a duct 84 passing axially therethrough. The positioner 80 and/or its duct 84 are preferably coaxial with the axis X1. The limiter 73 is mounted within the positioner 80 by sliding axially relative to the positioner 80. More generally, the secondary part 66 of the thermo-actuator 62 is movable relative to the positioner 80 between a normal stroke position, which corresponds to a low position of the part 66 with respect to the positioner 80 that is visible, for example, in FIGS. 7, 8 and 10, and higher over-travel positions that are visible for example in FIGS. 5, 6 and 9.

In the duct 84, the positioner 80 comprises an axial surface that faces downwards and is formed, in the present example, by a collar 85 of the positioner 80. The collar 85 is preferably radial and protrudes internally into the duct 84 at the upper end of the positioner 80. The secondary part 66 of the thermo-actuator 62 comprises an axial surface, facing upwards, which is formed, in the present example, by a collar 75 of the limiter 73. Preferably, the collar 75 is radial and external at the lower end of the limiter 73. The adjuster 50 comprises an over-travel spring 90 that is axially interposed between the positioner 80 and the secondary part 66, more precisely between the axial surface of the positioner 80 and the axial surface of the secondary part 66. The spring 90 is preferably a compression spring, for example helical coaxial with the axis X1. The spring 90 preferably extends in the duct 84, around and axially along the limiter 73. By means of elasticity, the spring 90 mechanically exerts an axial return force on the secondary part 66 by pressing on the positioner 80. This effort tends to return and maintain the secondary part 66 in the normal stroke position, especially when the secondary part 66 passes into the over-travel position.

The secondary part 66 comprises an axial surface facing downwards and that is advantageously formed by an outer conical flange 76 of the limiter 73, while the positioner 80 comprises an axial surface facing upwards and that is advantageously formed by a conical surface formed on the top of the collar 85, to form an axial stop limiting the displacement of the secondary part 66 to the normal stroke position, when the secondary part 66 is moved from the over-travel position to the normal stroke position.

The secondary part 66 comprises an axial surface facing upwards that is advantageously formed by the top of the collar 75 of the limiter 73, while the positioner 80 comprises an axial surface facing downwards that is advantageously formed by an internal shoulder 86 provided in the duct 84 in order to form an axial stop that limits the displacement of the secondary part 66 to the over-travel position when the secondary part 66 is moved from the normal stroke position to the over-travel position.

To ensure the operation described here, it is provided that the over-travel spring 90 has a higher stiffness, for example twice as high as the stiffness of the spring 63.

The adjuster 50 comprises a mechanical connection, through which the controller 3 actuates the positioner 80, which effects the following operation:
as shown in FIGS. 5 and 6, the positioner 80 is held in the retracted position, i.e. fixed in its low axial position with respect to the chamber 16 when the controller is moved from the initial position to an intermediate position that is between the initial position and the terminal position, and
as shown in FIGS. 7 to 10, the positioner 80 is moved relative to the chamber 16 from the retracted position to the extended position when the controller 3 is moved from an intermediate position to the terminal position.

Preferably, the intermediate position is between 35 and 70° with respect to the initial position, in particular between 55 and 70°, or at an equivalent proportion of the total stroke of the controller 3.

Between the intermediate position and the terminal position, the translation of the positioner 80 is performed at a pitch, preferably a constant pitch, relative to the rotation of the controller 3. The mechanical connection of the adjuster 50 then advantageously provides a screw-nut connection function. For this angular sector of the controller 3, each change of orientation of the controller 3 corresponds to a change of the axial position of the positioner 80. The mechanical connection of the adjuster 50 may then be described as “engaged”.

Between the initial position and the intermediate position, the mechanical connection disconnects the rotation of the controller 3 from the translation of the positioner 80, so that the positioner 80 remains fixed axially relative to the chamber 16, whatever the orientation of the controller 3 about the axis X1 in this angular sector. The mechanical connection of the adjuster may be described as “disengaged”. In this situation, it is preferred that the positioner 80 is completely fixed with respect to the chamber 16, but it could be provided that the positioner 80 is only axially fixed while being rotatable about the axis X1. It could also be provided that, in this situation, the positioner 80 is axially displaced over a negligible distance, or at a very small pitch with respect to the displacement pitch effected between the intermediate position and the terminal position.

It is preferred that the intermediate position is reached between the single-opening position and the double-opening position, preferably closer to the double-opening position, as is the case in the present example.

Alternatively, the initial position may be between the double-opening position or the terminal position, preferably being closer to the double-opening position. However, it may be provided that the intermediate position is reached between the initial position and the single-opening position in the vicinity of the single-opening position. It could also be provided that the intermediate position is coincident with the double-opening position. It could further be provided that the intermediate position is coincident with the single-opening position.

As the positioner 80 is kept in the retracted position on the sector extending from the initial position to the intermediate position, it is ensured that, for this sector, the compression of the spring 90 is not too high, which makes it possible to preserve the spring 90, as illustrated in FIGS. 5 and 6. In fact, the axial displacement downwards of the positioner 80 is limited to the retracted position visible in FIGS. 5 and 6, so that the total stroke of the positioner 80 is relatively low, wherein the positioner 80 effects this stroke only when its displacement is of interest for the operation of the cartridge 1, i.e. essentially when regulation of the outlet temperature must be carried out by the adjuster 50 between the double-opening position and the terminal position of the controller 3.

At least when the regulator 20 authorizes the establishment of a flow rate for the two flows F1 and C1, in particular between the double-opening position and the terminal position, the regulator 20 performs a thermostatic regulation of the outlet temperature of the outgoing flow. M1, as is the case in FIGS. 7 to 10. For this, the axial position of the shutter 52 is modified by the regulator 20, both as a function of the axial position of the positioner 80, which depends directly on the position of the controller 3, and both as a function of the relative position of the primary part 64 and the secondary part 66 of the thermo-actuator 62, wherein the latter is determined by the outlet temperature itself. The adjuster 50 is able to limit or completely close the flow C1 by moving the shutter 52 to the safety position, especially when the controller 3 is positioned in the vicinity and slightly after the double-opening position. The regulator 20 is able to limit or completely close the flow F1 by moving the shutter 52 to the opposite position, especially when the controller 3 is positioned in the vicinity and slightly before the terminal position. In the vicinity of the double-opening position, as illustrated in FIG. 7, the position of the positioner 80 is such that, despite being placed in a retracted position, or in a low protruding position of the secondary part 66, the shutter 52 is in the safety position, or almost in the safety position. In the terminal position, as shown in FIG. 10, the position of the positioner 80 is such that, despite a protruding position of the secondary part 66, the shutter is in the opposite position.

Preferably, when the controller 3 is positioned on a range extending from the initial position to a non-forcing position between the initial position and the terminal position, the secondary part 66 of the thermo-actuator 62 is held at the over-travel position against the return force of the over-travel spring 90, while the shutter 52 is kept in the safety position regardless of the position of the secondary part 66 relative to the primary part 64. In particular, the shutter 52 is pressed axially downwards, so that the secondary part 66 is in the retracted position or in the protruding position. This situation is shown, for example, in FIGS. 5 and 6. More precisely in this situation, the positioner 80 is in the retracted position, or in a position low enough for the shutter 52 to be kept in the safety position, even if the secondary part 66 is in the retracted position. In this situation, the over-travel spring 90 forces the shutter to be in the safety position at full cold.

When the controller 3 is between the non-forcing position and the terminal position, the secondary part 66 of the thermo-actuator 62 is free to reach the normal stroke position, in particular when the secondary part 66 is in the retracted position, or even for certain protruding positions, as is the case in FIGS. 7, 8 and 10. In this range of positions of the controller, the secondary part 66 may be placed in the protruding position in order to compensate for an over-travel of the thermo-actuator 62, if the shutter 52 is in the safety position and if the secondary part 66 is placed in a sufficiently strong protruding position, as is the case in FIG. 9. The over-travel spring 90 is then compressed and thus absorbs the excess axial length of the thermo-actuator 62 to prevent damage to the cartridge 1. In this range of positions of the controller 3, the over-travel spring 90 plays the function of over-travel compensation. Such over-travel compensation occurs, in particular, when the outlet temperature is greater than a threshold value as determined both by the position of the controller 3 and by the design of the thermo-actuator 62, for example when the water pressure of the cold water supplied to the orifice 10 is very low in comparison with the pressure of hot water supplied to the orifice 12. The regulator 20 then closes the flow C1 by placing the shutter 52 in the safety position, which prevents burning of the user.

Preferably, the non-forcing position is between the intermediate position and the terminal position, close to the intermediate position. It is preferred that the non-forcing position is between 65° and 70° with respect to the initial position, or an equivalent proportion of the total stroke of the controller 3.

Alternatively, the non-forcing position is between the double-opening position and the terminal position, near the double-opening position. In particular, it may be provided that the non-forcing position is coincident with the double-opening position.

In the present example, the nut 40 comprises a through housing 43 that is coaxial with the axis X1. Preferably, this housing 43 comprises a lower part, opening downwards, through which the secondary part 66 passes.

Advantageously, this housing 43 comprises an upper part, which may have a larger diameter, and that opens upwards. Within this housing, one or more meshing paths are hollowed out. In this example, three paths are provided, as explained below.

From the top of the housing 43, each path comprises an internal thread 44, i.e. a helical groove coaxial with the axis X1. Each thread 44 extends over only a part of the axial length of the housing 43, called the “engaging part”. In the present example, the three threads 44 are interlaced.

Towards the bottom, each path comprises, in the continuity of the concerned thread 44, a radial notch 45 formed in a recess in the housing 43 and extending the thread 44. In other words, each notch 45 starts at the end of the thread 44 of the concerned path, at the bottom of this thread 44. The notches 45 extend axially over only a part of the axial length of the housing 43, referred to as the “disengaging part” that starts immediately at the bottom of the engaging part. Each notch 45 extends in the same plane orthogonal to the axis X1. Each notch 45 is hollowed out radially outwards, i.e. it increases the diameter of the housing 43 locally. Each notch 45 extends over only a part of the circumference of the housing 43 about the axis X1, for example less than 90°. The notches 45 are separated from each other by being evenly distributed about the axis X1. The notches 45 are advantageously radially through, but could be radially blind. Alternatively, in the case of discrete notches 45 as shown, one could provide a notch or groove that would be continuous over the entire circumference and recessed in the housing 43. In this case, a single continuous groove would form the radial notch of several or all the meshing paths.

Each meshing path, therefore, describes an oblique trajectory, more precisely a helical path, at the height of its thread 44, and a trajectory forming an arc of a circle in a plane orthogonal to the axis X1, at the height of its radial notch 45.

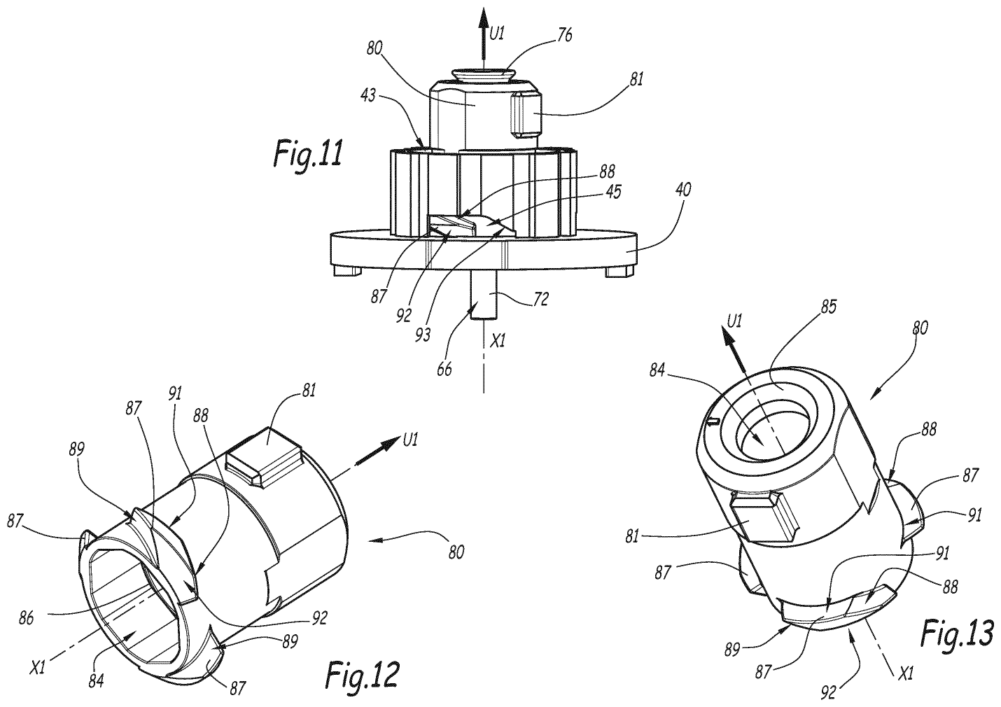

The positioner 80 is coaxially movable in this housing 43 so as to be surrounded by the nut 40, as may be seen in FIG. 11. The positioner 80, shown alone in FIGS. 12 and 13, comprises one or more teeth 87, in the present example three teeth 87, that are able to be respectively meshed, i.e. to guided, in the threads 44 and the notches 45 of the meshing path. Advantageously, the same number of teeth 87 is provided as threads 44 and notches 45. The teeth 87 extend in the same orthogonal plane with respect to the axis X1, preferably towards the bottom of the positioner 80. Each tooth 87 projects radially outwards from an outer wall of the positioner 80, i.e. increasing the diameter of the positioner 80 locally. Each tooth 87 extends over only a part of the circumference of the positioner 80 about of the X1 axis. The teeth 87 are separated from each other by being regularly distributed about the axis X1.

Each tooth 87 occupies an angular sector less than 360°, preferably less than 90° about the axis X1. In the present example, each tooth 87 occupies an angular sector between about 70° and 80° about the axis X1. Preferably, it is provided that each tooth 87 extends over an angular sector corresponding to this range of values, which is at the same time:
sufficiently high to allow reliable meshing with the threads 44,
sufficiently low, not only to ensure the operation mentioned below by interaction with the corresponding meshing path, but also to allow the manufacture of the positioner 80 through molding, wherein the faces of the positioner 80 are all oriented in relief relative to a joint plane comprising the axis X1 and passing through, for example, the tooth 81.

Therefore, the positioner 80 is both reliable and particularly easy to manufacture.

The axial length of the tooth 87 is preferably equal to, or slightly less than, the axial length of the notch 45.

The axial length of each tooth 87 is, for example, close to the value of the pitch of the corresponding thread 44.

Each tooth 87 preferably forms a helical thread portion that is coaxial with the axis X1 just like the thread 44.

Preferably, as may be seen in FIGS. 11 to 13, each tooth 87 comprises, axially with respect to the axis X1, two walls 88 and 89, inclined obliquely opposite with respect to the axis X1, in order to present a helical shape locally. The wall 89 faces downwards in order to slide against a part of the thread 44 extending below the tooth 87 in question, while the other inclined wall 88 faces upwards in order to slide against a part of the thread 44 extending above the tooth 87 in question.

Each tooth 87 comprises axially with respect to the axis X1, two opposite axial walls 91 and 92, at least one of which, preferably the wall 91 at the top, is parallel to a plane orthogonal to the axis X1. These walls 91 and 92, or at least the top wall 91, are provided to slide along the walls of the notch 45 in question. Preferably, these walls 91 and 92 connect the inclined walls 88 and 89 to each other.

In the preferred embodiment shown, each tooth 87 has a contour in the form of a non-rectangular parallelogram or trapezoid, with two opposite axial walls 91 and 92 connected by two opposite oblique walls 88 and 89 as may be seen, in particular, in FIG. 13. Thus, each tooth 87 meshes with a maximum of the thread 44 in question, while being able to be engaged in the notch 45 in question without hindering the rotation of the controller 3.

The notch 45 advantageously comprises walls with a shape corresponding to that of the walls of the teeth 87. Consequently, each tooth 87 may be housed entirely in the notch 45, so that the angular stroke of the nut 40 is particularly important. In particular, the notch 45 comprises an oblique wall 93 corresponding to the oblique wall 88 of the tooth 87.

Alternatively, it is expected that a single wall of the tooth 87 is oblique, or that no wall is oblique.

Thanks to the threads 44, the notches 45 and the teeth 87, the mechanical connection of the adjuster 50 allows:
when the controller 3 is moved from the initial position to the intermediate position, the positioner 80 is held in the retracted position by axial engagement of the teeth 87 in their respective notches 45, wherein the nut 40 rotates without the positioner 80 being axially displaced; and
when the controller 3 is moved beyond the intermediate position, to the terminal position, the positioner 80 is moved relative to the chamber 16, from the retracted position to the extended position by meshing the teeth 87 with the threads 44 in the manner of a helical link.

One could provide a single radial tooth associated with a single meshing path, or two radial teeth respectively associated with two meshing paths. However, it is preferred to provide three radial teeth respectively associated with as many meshing paths to ensure that the actuation of the mechanical connection has a particularly low clearance, high accuracy and high durability, without substantial damage to the mechanical reliability of this connection. If necessary, it would be possible to provide more radial teeth respectively associated with as many meshing paths, in order to reinforce the reliability of the mechanism.

One could provide the opposite arrangement to that of the illustrated example, wherein the meshing paths are provided on the positioner 80 and wherein the radial teeth are provided on the nut 40. In any case at least one radial tooth is provided on a first member of the controller 3 and the positioner 80, and at least one meshing path of this radial tooth is provided on a second member of the controller 3 and the positioner 80.

The cartridge of the illustrated example makes it possible to implement an operating method, in which, when the controller 3 is moved from the initial position to the intermediate position, the positioner 80 is kept in the retracted position, and when the controller 3 is positioned between the intermediate position and the terminal position, the positioner 80 is moved from the retracted position to the extended position.

1.-10. (canceled)

11. A cartridge for a mixing valve, wherein the cartridge comprises:
two inlets of incoming flows of liquid;
a chamber, designed to form an outgoing flow by mixing the incoming flows;
a controller, which is movable relative to the chamber between an initial position and a terminal position, passing through an intermediate position between the initial position and the terminal position;
an adjuster, which comprises:
a positioner, which is movable relative to the chamber upon being actuated by the controller, so as to be displaced relative to the chamber from a retracted position to an extended position when the controller is moved from the intermediate position to the terminal position;
a shutter, which is movable relative to the chamber for differentially modifying the respective flow rate of the incoming flows;
a thermo-actuator, which comprises a primary part fixedly attached to the shutter and a secondary part moving relative to the primary part as a function of an outlet temperature of the outgoing flow; and
an over-travel spring, which is interposed between the positioner and the secondary part of the thermo-actuator;
wherein the positioner is held in the retracted position when the controller is moved from the initial position to the intermediate position.

12. The cartridge according to claim 11, wherein:
the cartridge defines a main axis that is fixed with respect to the chamber;
the controller is pivotally movable about the main axis, from the initial position to the terminal position, relative to the chamber;
the positioner is movable in translation parallel to the main axis, from the retracted position to the extended position, relative to the chamber; and
the adjuster comprises a mechanical connection, through which the controller actuates the positioner, wherein the mechanical connection comprises:
at least one radial tooth, projecting radially from the main axis of a first member of the controller and the positioner;
at least one meshing path of the radial tooth, which is recessed in a second member of the controller and the positioner.

13. The cartridge according to claim 12, wherein each meshing path comprises:
a helical thread, which is coaxial with the main axis, so that when the controller is moved from the intermediate position to the terminal position, the positioner is moved relative to the chamber from the retracted position to the extended position by meshing of the radial tooth with the helical thread; and
a radial notch, beginning at the end of the helical thread and extending in a plane orthogonal to the main axis, so that when the controller is moved from the initial position to the intermediate position, the positioner is held in the retracted position by axial engagement of the radial tooth in the radial notch.

14. The cartridge according to claim 11, wherein the shutter is movable relative to the chamber, between:
a safety position in which the shutter closes the first incoming flow and allows the second incoming flow; and
an opposite position in which the shutter closes the second incoming flow and authorizes the first incoming flow.

15. The cartridge according to claim 11, wherein:
the secondary part of the thermo-actuator is movable relative to the positioner between a normal stroke position and an over-travel position; and
the over-travel spring exerts a return force on the secondary part that tends to return the secondary part to the normal stroke position, when the secondary part is brought into the over-travel position.

16. The cartridge according to claim 11, wherein:
the shutter is movable relative to the chamber, between:
a safety position in which the shutter closes the first incoming flow and allows the second incoming flow; and
an opposite position in which the shutter closes the second incoming flow and authorizes the first incoming flow;
the secondary part of the thermo-actuator is movable relative to the positioner between a normal stroke position and an over-travel position;
the over-travel spring exerts a return force on the secondary part that tends to return the secondary part to the normal stroke position, when the secondary part is brought into the over-travel position;
the secondary part of the thermo-actuator moves relative to the primary part from at least one retracted position to at least one extended position as a function of the outlet temperature; and
the controller passes through a non-forcing position, when it is moved between the initial position and the terminal position, so that:
when the controller is between the initial position and the non-forcing position, the secondary part of the thermo-actuator is held in the over-travel position against the return force of the over-travel spring, while the shutter is held in the safety position, regardless of the secondary part being in the retracted position or in the extended position, and
when the controller is between the non-forcing position and the terminal position, the secondary part of the thermo-actuator is in the normal stroke position at least when the secondary part is in the retracted position.

17. The cartridge according to claim 11, wherein:
the controller passes through a single-opening position, when it is moved between the initial position and the intermediate position, and by a double-opening position, when it is moved between the intermediate position and the terminal position; and
the cartridge further comprises a regulator that is designed to differentially modify the respective flow rate of the incoming flows as a function of the position of the controller, so that when the controller:
is between the initial position and the single-opening position, the two incoming flows are closed by the regulator;
is between the single-opening position and the double-opening position, one of the incoming flows is closed by the regulator, while the other incoming flow is allowed by the regulator; and
is between the double-opening position and the terminal position, the two incoming flows are allowed by the regulator.

18. The cartridge according to claim 11, wherein the adjuster further comprises a return spring which is interposed between the shutter or the primary part and the chamber.

19. A mixing valve comprising a cartridge according to claim 11.

20. A method of operation of a cartridge according to claim 11, wherein:
moving the controller from the initial position to the intermediate position, while holding the positioner in the retracted position; and
positioning the controller between the intermediate position and the terminal position by moving the positioner from the retracted position to the extended position.
